(19) United States
(12) Patent Application Publication
(10) Pub. No.: US 2010/0242183 A1
(43) Pub. Date: Sep. 30, 2010

(54) MULTI PURPOSE TOOL WITH A DETACHABLE TOOL HANDLE

(76) Inventor: MICHAEL D. REDFERN, Seattle, WA (US)

Correspondence Address: Patent Prep and Pros Group;Scott A. Schlack, 4632 159th St. S.W., Lynnwood, WA, 98087, US

(21) Appl. No.: 12/413,462

(22) Filed: Mar. 27, 2009

(51) Int. Cl. B25B 7/22; B25B 15/00; B25B 15/04

(52) U.S. Cl. 7/128; 7/165; 81/60

(57) ABSTRACT

A multi purpose tool includes a pivotally joined pair of lever arms. The first lever arm includes both a first jaw portion having an elongate aperture and a first handle portion. The second lever arm includes both a second jaw portion having a pivot member and a second handle portion. One of the first and second handle portions comprise a detachable tool that attaches to the multi purpose tool by connecting with an elongate joining portion. The elongate joining portion fits inside a first end of the detachable tool. A second end of the detachable tool includes a bit retainer.

### FIELD OF THE INVENTION

The present invention relates to a specialized multi-purpose tool that has a detachable tool as one of its handle arms. The detachable tool can either be used in combination with the multi-purpose tool as a driver with a high torque capacity or as an independent driver tool with lesser torque capacity that operates separately from the multi-purpose tool.

### BACKGROUND OF THE INVENTION

Many different types of multi-purpose tools today include plier functionality in combination with various other accessory tools. For example, the Leatherman™ company makes a popular product-line of multi-tools having various sizes and capabilities. Most of these multi-tools include a small pair of fixed-joint pliers with other accessory tools stored in the multi-tool handles. These fixed-handle accessory tools generally include a knife, a file, a flat-head screwdriver, a Phillips-head screwdriver, a can-opener, scissors, and various other assorted tools.

The Leatherman™ type multi-tools on the market today are purposely configured to be compact in design and light-weight in structure, such that they can easily be stored in a belt holster and used in a fashion similar to a Swiss Army Knife™. Typically, all of the accessory tools are designed to fold out from within a container that resides inside the tool handle. These fold-out tools are relatively small, simplistic, and blunt in design, compared with their equivalent discrete hand-tool counterparts.

It has been found that it is very difficult to design a multi-tool including a slip-joint plier having a substantially wide object-gripping capability (e.g., with the ability to grip around the diameter-width of a circular pipe), which is capable of folding inside the multi-tool handles in a compact fashion. Another common design problem for multi-tools is providing adequate in-use torque for practical, real-world use, such as that required for use in various service professions (e.g., plumbers, electricians, builders, general purpose handymen, etc.).

As is well-known, torque is often defined as a rotational force transferred down a shaft axis from a point of force application on a lever arm. The magnitude of a torque is directly proportional to a magnitude of the applied force (including the angle of force application) multiplied by a length of the lever arm between the rotational axis and the point of force application. One example of a high-torque tool is a ratcheting socket wrench having a substantially long handle arm (e.g., a handle length between 5-10 inches, See e.g., U.S. Pat. No. 3,283,621). This wrench facilitates the application of a significant amount of torque down a shaft axis to a socket tool because of its handle length. In contrast, most multi-tools have handles ranging between 2-5 inches in length, giving them relatively low torque capability. This lack of torque-based functionality makes these tools impractical for most service professions.

There are several issued U.S. patents that have combined a full-size discrete pliers tool with fixed tools at part of the pliers' handle arms. For example, U.S. Pat. Nos. 7,134,366 and 7,134,366, each disclose multi-purpose pliers with fixed handles having bit receptacles at the handle ends. In addition, U.S. Pat. No. 5,910,174 discloses a pliers-based tool with a fixed handle tool hidden beneath a removable sleeve. None of these patented multi-purpose pliers tools allow for the pliers to be securely locked in a high-torque position for driving or removing a tough, friction-locked bolt or screw into or out of a rigid medium. Further, none of these patented pliers tools have a detachable tool that can be removed from the pliers tool and used independently in confined spaces where the pliers themselves would not normally be able to fit.

Therefore, there continues to be a need for an improved full-size multi-purpose tool that can be advantageously and practically used in the service professions.

### SUMMARY OF THE INVENTION

In overcoming the above disadvantages associated with the prior art, a multi-purpose tool made in accordance with the present invention includes, but is not limited to, a pivotally joined pair of lever arms. The first lever arm includes both a first jaw portion having an elongate aperture and a first handle portion. The second lever arm includes both a second jaw portion having a pivot member and a second handle portion. Either the first or the second handle portion may include both an elongate joining portion and a detachable tool, where the elongate joining portion connects with the detachable tool.

In accordance with an aspect of the invention, the pivot member slidably adjusts along a length of the elongate aperture such that the second jaw portion changes in horizontal position relative to the first jaw portion.

In accordance with a further aspect of the invention, the elongate joining portion fits inside a first end of the detachable tool.

In accordance with another aspect of the invention, the detachable tool includes a second end having a bit retainer.

In accordance with yet another aspect of the invention, the second end of the detachable tool includes a ratchet mechanism.

In accordance with a further aspect of the invention, the first lever arm and the second lever arm include a locking means that locks the multi purpose tool in an open position.

In accordance with yet another aspect of the invention, a multi purpose tool includes a first lever arm having an elongate aperture and a handle portion, and a second lever arm having a pivot member and a driver tool that is detachable from the second lever arm.

### DESCRIPTION OF THE DRAWINGS

Preferred and alternative examples of the present invention are described in detail below with reference to the following Figure drawings:

FIG. 1 illustrates a perspective front-side view of a multi purpose tool, in accordance with an embodiment of the present invention;

FIG. 2 illustrates a perspective front-side view of a multi purpose tool locked in an open position, in accordance with an embodiment of the present invention;

FIG. 3 illustrates a perspective back-side view of a multi purpose tool in a closed position, in accordance with an embodiment of the present invention;

FIG. 4 illustrates a perspective front-side view of a detachable driver tool in accordance with an embodiment of the present invention; and

FIGS. 5(A-C) illustrate perspective side views of various elongate joining portions in accordance with various embodiments of the present invention.

### DETAILED DESCRIPTION

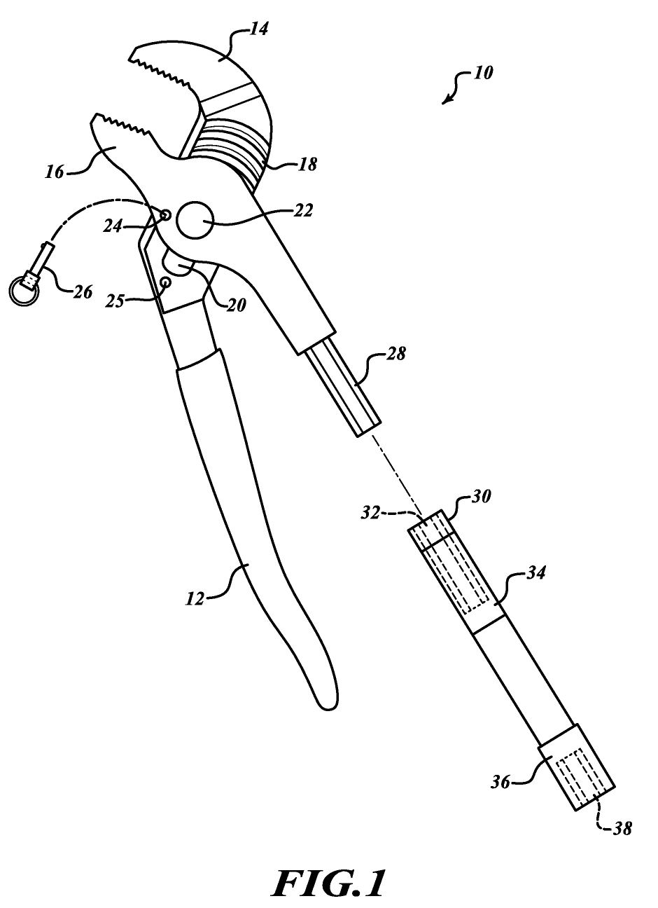

In accordance with an exemplary embodiment of the present invention, FIG. 1 shows a multi-purpose tool 10 having a detachable tool handle 30. In this embodiment, the multi-purpose tool 10 is a slip-joint pliers tool with two pivotally joined lever arms. The first lever arm includes: a first jaw portion 14 adapted for gripping the upper end of a fixture or a pipe needing to be secured or rotated about a particular azimuthal axis (not shown); an elongate aperture 20 and a series of horizontal adjustment grooves 18 allowing the multi-purpose tool 10 to slidably lock into a fixed jaw-width position; a first hole aperture 25 for locking the multi-purpose tool 10 in a high-torque, open position; and a first handle portion 12 for allowing a user of the multi-purpose tool 10 to grip and maneuver the first lever arm of the multi-purpose tool 10. The second lever arm includes: a second jaw portion 16 adapted for gripping the lower end of a fixture or a pipe needing to be secured or rotated about a particular azimuthal axis (not shown); a pivot member 22 for securing the first and second lever arms together and for allowing the second lever arm to slidably adjust along a length of the elongate aperture 20; a second hole aperture 24 for locking the multi-purpose tool 10 in a high-torque, open position; an elongate joining portion 28 for securing the detachable tool 30 to the multi-purpose tool 10; and a detachable tool 30 that is separable from the elongate joining portion 28 of the multi-purpose tool 10, for allowing a user of the multi-purpose tool 10 to grip and maneuver the second lever arm as part of the multi-purpose tool 10, and for allowing a user of the detachable tool 30 to use the detachable tool 30 as a separate driver tool.

In an embodiment, the detachable tool 30 may include an elongate joining recess 32 at its first end, closest to the elongate joining portion 28; a circumferential gripping region 34 around the exterior surface of the detachable tool 30; a ratchet mechanism 36, along with a bit-retainer 38 at the second end of the detachable tool 30, furthest from the elongate joining portion 28. The elongate joining recess 32 is adaptively shaped to fit the shape of the elongate joining portion 28. The circumferential gripping region 34 may include a serrated metal etching, a rubber grip, a plastic grip, or any other grip material that facilitates secured handling of the detachable tool 30. In an embodiment, the circumferential gripping region 34 may extend over the entire surface area of the multi-purpose tool 10. In another embodiment, the circumferential gripping region 34 may extend over only a portion of the surface area of the multi-purpose tool 10. The ratchet mechanism 36 may include any number of ratcheting mechanisms commonly used in ratcheting hand tools, so long as the distance between ratchet lock-notches offers a substantially small angle of rotation between locking points. This allows for the multi-purpose tool 10 to be used in tight spaces where a wide angle of handle rotation is not available. The bit retainer 38 may include a standard hexagonal shape bit retainer or any other common bit retainer shape that would facilitate the use of varying specialized tool bits, such as driver tool bits and socket tools.

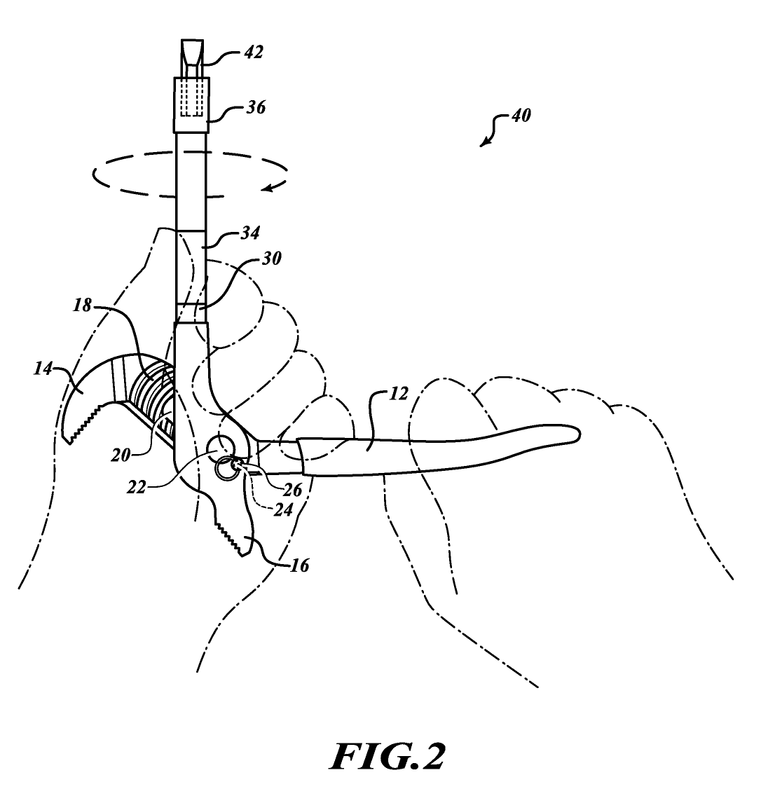

The multi-purpose tool 10 also includes a locking pin 26 that may be simultaneously positioned inside both the first hole aperture 25 and the second hole aperture 24, when the hole apertures are aligned in a high-torque, locked position. In an alternate embodiment the detachable tool 30 and the elongate joining portion 28 may be adapted to be part the first lever arm instead of the second lever arm, without departing from the spirit and scope of the invention. In accordance with an embodiment of the invention, FIG. 2 illustrates a multi-purpose tool 40 being used in a high-torque, locked position. By way of example, when a particular user of the multi-purpose tool 40 desires to drive a screw into a particular medium in the clockwise direction, the multi-purpose tool 40 may be opened by the user grasping and separating the first handle portion 12 from the detachable tool 30, until the first hole aperture 25 and the second hole aperture 24 align. In an embodiment, this alignment occurs when there is approximately a 90 degree angle of separation between the first handle portion 12 and the detachable tool 30. A user may then push the locking pin 26 inside the aligned hole apertures, thereby locking the multi-purpose tool 40 in an open position. In this position, the first handle portion 12 and the detachable tool 30 form an “L-shape” with respect to one another, and the pivot member 22 is positioned near the lower end of the elongate aperture 20.

In accordance with another embodiment, the first hole aperture 25 and the second hole aperture 24 may be respectively positioned near the top the first jaw portion 14 and the second jaw portion 16, such that the hole apertures align when the pivot member 22 is positioned near the upper end of the elongate aperture 20. Various other locking means may also be adapted to lock the multi-purpose tool 40 in an open position without departing from the spirit and the scope of the invention. These alternate locking means may include, but are not limited to, latch-locking mechanisms, various other pin-locking mechanisms, notched-fit locking mechanisms, and any other variety of ordinary mechanical locking devices that could achieve a similar effect as the previously presented locking means.

Once the multi-purpose tool 40 is locked in the open position, a user may insert a tool bit, such as a flathead screwdriver bit 42, in the bit retainer 38. In this configuration, the multi-purpose tool 40 may be used to drive or remove a screw or bolt in a similar fashion to typical “L-shaped” ratchet tool with a socket extension. To effectively drive or remove a screw or bolt, the requisite angle of rotation about an imaginary axis (not shown), aligned along the center of the detachable tool 30, may be substantially small due to the ratchet mechanism 36 functionality. A force applied at the first handle portion 12, may be transferred down a shaft axis of the detachable tool 30 to the flathead screwdriver bit 42. The magnitude of a generated torque is directly proportional to the magnitude of the applied force and the length of the first handle portion 12. The locking pin 26 prevents the lever arms of the multi-purpose tool 40 from slipping along a length of the elongate aperture 20, or inadvertently transitioning into a closed position, substantially less than a 90 degree angle between the first handle portion 12 and the detachable tool 30.

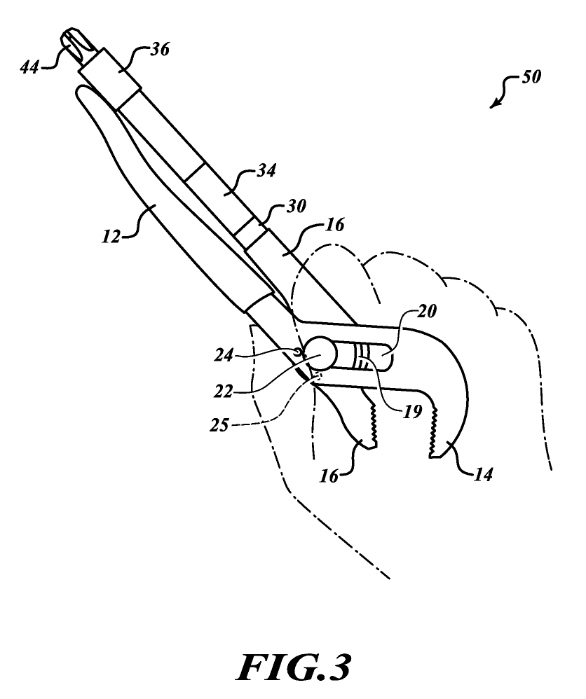

FIG. 3 Illustrates an embodiment of the invention where a multi-purpose tool 50 is in a closed position. In this configuration, there is approximately less than a 5 degree angle of separation between the first handle portion 12 and the detachable tool 30. The pivot member 22 is positioned at the base of the elongate aperture 20 of the multi-purpose tool 50, and adjustment grooves 19 may be configured to help lock the multi-purpose tool 50 into a fixed jaw-width position. A Philips-head bit 44 may be positioned inside the second end of the detachable tool, within the bit retainer 38. The surface area of the combined a first jaw portion 14 and the second jaw portion 16 portion allow for a user to easily grip and rotate the tool with a low to moderate amount of torque, sufficient for ordinary driver function. The length-of-reach of the closed multi-purpose tool 50, with the detachable tool 30, facilitates the tool being used in confined spaces where an extended reach may be required.

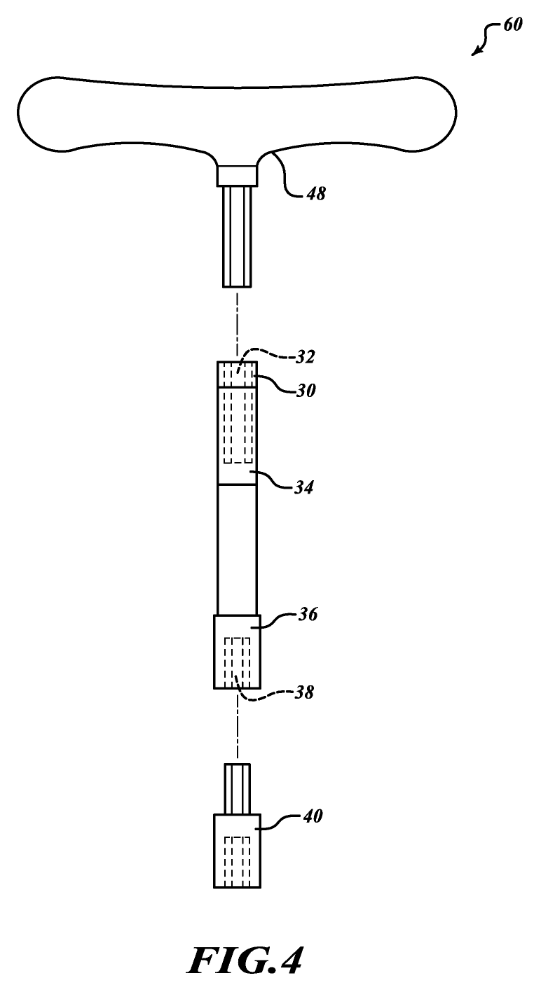

In accordance with another embodiment of the invention, FIG. 4 illustrates a detachable tool 60 which can be used independently from the multi-purpose tool 50. By way of example, if a user wishes to start a screw or bolt in a particular medium that offers only minimal initial/starting resistance, the detachable tool 60 would be an easier, more-sensitive (e.g., due to the fact the a user's hand may be closer to the object being driven) means for user to start the screw or bolt. After the screw or bolt reached a point of stiffer resistance, requiring higher torque, the detachable tool 60 may then be combined with a multi-purpose tool 50 to finish driving the screw or bolt. In an embodiment, the detachable tool 60 includes a “T-handle” 48 that may be inserted into the elongate joining recess 32 at the detachable tool's 60 first end. The “T-handle” 48 facilitates only a moderate amount of torque, on an order of magnitude that is in line with a magnitude of torque capable of being produced by the multi-purpose 50 tool configuration illustrated in FIG. 3. For driving a hex-head bolt, the detachable tool 60 may be fit with a hex bolt socket 40 that can be inserted into the bit-retainer 38 at the detachable tool's 60 second end.

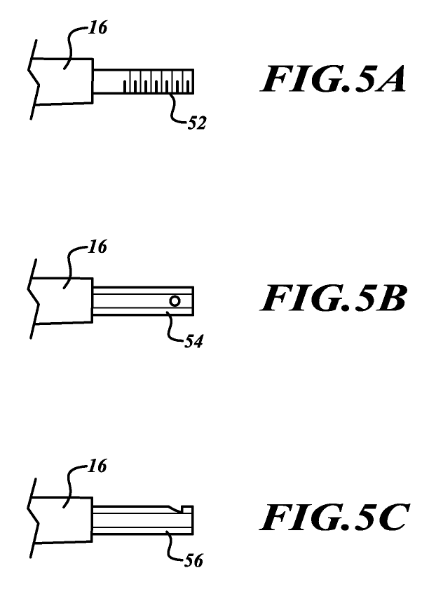

FIGS. 5(A-C) illustrate elongate joining portions 16 in accordance with varying embodiments of the present invention. FIG. 5A depicts an elongate joining portion including a screw connector 52. In this embodiment, the elongate joining recess 32 of the detachable tool 30 may be threaded to fit the screw connector 52. This would offer a very secure fit of the detachable tool 30 to the multi-purpose tool 10, however, it would take more time to thread the screw connector 52 into a threaded elongate joining recess (not shown) than it would to connect the detachable tool 30 with either slip-fit elongate joining portion, illustrated in FIGS. 5B and 5C.

FIG. 5B illustrates an embodiment where the elongate joining portion 16 is a slip-fit hexagonal shaped joining member 54 with a ball and spring mechanism at its joining end. In this embodiment, the elongate joining recess 32 of the detachable tool 30 may include a dimple recess (not shown) to fit the spring-loaded ball of the ball and spring mechanism. The slip-fit hexagonal-shaped joining member 54 with a ball and spring mechanism offers a very quick and moderately secure fit of the detachable tool 30 to the multi-purpose tool 10.

FIG. 5C illustrates an embodiment where the elongate joining portion 16 is a slip-fit hexagonal shaped joining member 56 with a notch-lock mechanism at its joining end. In this embodiment, the elongate joining recess 32 of the detachable tool 30 may include a spring-loaded latch that fits inside and up against the flat-side notch portion of the notch-lock mechanism. The slip-fit hexagonal-shaped joining member 56 with the notch-lock mechanism offers a very quick and substantially more secure fit of the detachable tool 30 to the multi-purpose tool 10 than does the slip-fit hexagonal-shaped joining member 54 with a ball and spring mechanism.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A multi purpose tool comprising:
a first lever arm comprising:
a first jaw portion having an elongate aperture;
a first handle portion; and
a second lever arm comprising:
a second jaw portion having a pivot member; and
a second handle portion,
wherein at least one of the first and second handle portions comprise a detachable tool that attaches to the multi purpose tool by connecting with an elongate joining portion.

2. The multi purpose tool of claim 1, wherein the pivot member slidably adjusts along a length of the elongate aperture such that the second jaw portion changes in horizontal position relative to the first jaw portion.

3. The multi purpose tool of claim 1, wherein the elongate joining portion fits inside a first end of the detachable tool.

4. The multi purpose tool of claim 3, wherein the detachable tool further comprises a second end having a bit retainer.

5. The multi purpose tool of claim 4, wherein the second end of the detachable tool further comprises a ratchet mechanism.

6. The multi purpose tool of claim 1, wherein the first lever arm and the second lever arm further comprise a locking means that locks the multi purpose tool in an open position.

7. The multi purpose tool of claim 6, wherein the locking means comprises a hole aperture in each of the first and second lever arms, which align with each other in the open position.

8. The multi purpose tool of claim 7, wherein the locking means further comprises a pin member that fits within both hole apertures to lock the multi purpose tool in the open position.

9. The multi purpose tool of claim 1, wherein the elongate joining portion further comprises a screw portion.

10. The multi purpose tool of claim 1, wherein the elongate joining portion is of hexagonal shape and further comprises a ball and spring portion.

11. A multi purpose tool, comprising:
a first lever arm comprising:
an elongate aperture; and
a first handle portion; and
a second lever arm, comprising:
a pivot member; and
a second handle portion,
wherein at least one of the first and second handle portions comprise a detachable driver tool.

12. The multi purpose tool of claim 11, wherein the pivot member slidably adjusts along a length of the elongate aperture such that a portion of the second lever arm changes in horizontal position relative to a portion of the first lever arm.

13. The multi purpose tool of claim 11, wherein the second lever arm further comprises an elongate joining portion that fits inside a first end of the driver tool.

14. The multi purpose tool of claim 13, wherein the driver tool further comprises a second end having a bit retainer.

15. The multi purpose tool of claim 14, wherein the second end of the driver tool further comprises a ratchet mechanism.

16. The multi purpose tool of claim 11, wherein the first lever arm and the second lever arm further comprise a locking means that locks the multi purpose tool in an open position.

17. The multi purpose tool of claim 16, wherein the locking means comprises a hole aperture in each of the first and second lever arms, which align with each other in the open position.

18. The multi purpose tool of claim 17, wherein the locking means further comprises a pin member that fits within both hole apertures to lock the multi purpose tool in the open position.

19. The multi purpose tool of claim 13, wherein the elongate joining portion further comprises a screw portion.

20. The multi purpose tool of claim 13, wherein the elongate joining portion is of hexagonal shape and further comprises a ball and spring portion.
